(19) United States
(12) Patent Application Publication
(10) Pub. No.: US 2013/0021342 A1
(43) Pub. Date: Jan. 24, 2013

(54) NOISE REDUCTION AND FOCUSING ALGORITHMS FOR GMAPD

(71) Applicant: Vernon R. Goodman, Rockwall, TX (US)

(72) Inventor: Vernon R. Goodman, Rockwall, TX (US)

(73) Assignee: RAYTHEON COMPANY, Waltham, MA (US)

(21) Appl. No.: 13/554,611

(22) Filed: Jul. 20, 2012

Related U.S. Application Data
(60) Provisional application No. 61/510,998, filed on Jul. 22, 2011.

(51) Int. Cl. G06T 15/30

(52) U.S. Cl. 345/424

(57) ABSTRACT

An apparatus and method for processing of XYZ point clouds obtained from a GmAPD LADAR using low-pass filtering followed by high-pass filtering and deconvolution.

### CROSS-REFERENCE TO RELATED APPLICATIONS AND PRIORITY CLAIM

This application is a non-provisional of U.S. patent application Ser. No. 61/510,998, filed Jul. 22, 2011, the disclosure of which is incorporated by reference herein in its entirety.

### BACKGROUND

This disclosure relates generally to the field of imaging and more particularly to enhancing images obtained from Geiger mode Avalanche PhotoDiode detectors using three-dimensional statistical differencing.

Imaging sensors such as laser radar sensors (LADARs) acquire point clouds of a scene. The point clouds of the scene are then image processed to generate three dimensional (3D) models of the actual environment of the scene. The image processing of the 3D models enhances the visualization and interpretation of the scene. Typical applications include surface measurements in airborne and ground-based industrial, commercial and military scanning applications such as site surveillance, terrain mapping, reconnaissance, bathymetry, autonomous control navigation and collision avoidance and the detection, ranging and recognition of remote military targets.

Presently there exist many types of LADARs for acquiring point clouds of a scene. A point cloud acquired by a LADAR typically comprise x, y & z data points from which range to target, two spatial angular measurements and strength (i.e., intensity) may be computed. However, the origins of many of the individual data points in the point cloud are indistinguishable from one another. As a result, most computations employed to generate the 3D models treat all of the points in the point cloud the same, thereby resulting in indistinguishable “humps/bumps” on the 3D surface model of the scene.

Various imaging processing techniques have been employed to reconstruct the blurred image of the scene. The blurring or convolution of the image is a result of the low resolution (i.e., the number of pixels/unit area) of the intensity images at longer distances and of distortion of the intensity image by the LADAR optics and by data processing. Accordingly, the image must be de-blurred (deconvolved).

Relevant herein, LADARs may comprise arrays of avalanche photodiode (APD) detectors operating in Geiger-mode (hereinafter “GmAPD”) that are capable of detecting single photons incident onto one of the detectors. FIG. 1 diagrammatically depicts a typical GmAPD LADAR 10 including focal plane arrays 12 of avalanche photodiode (APD) detectors 14 operating in Geiger-mode. Integrated timing and readout circuitry (not shown) is provided for each detector 14. In typical operation, a laser pulse emitted from a microchip laser 16 passes through a bandpass filter 18, variable divergence optics 20, a half-wave plate 22, a polarizing beam splitter 24, and is then directed via mirrors 26 and 28 through a beam expander 30 and a quarter wave plate 32. Scanning mirrors 34 then steer the laser pulses to scan the scene 36 of interest. It is noted that the scanning mirrors 34 may allow the imaging of large areas from a single angle of incidence or small areas imaged from a variety of angles on a single pass. Return reflections of the pulse from objects in the scene 36 (e.g., tree and tank) pass in the opposite direction through the polarizing beam splitter 24, a narrow band filter 38, and then through a zoom lens 40 onto the detector array 12. The outputs of the detector array 12 forming a point cloud 42 of XYZ data are then provided to an image processor 44 for viewing on a display 46.

More particularly, the operation of a GmAPD LADAR occurs as follows. After the transmit laser pulse leaves the GmAPD LADAR, the detectors 14 are overbiased into Geiger-mode for a short time, corresponding to the expected time of arrival of the return pulse. The window in time when the GmAPD is armed to receive the return pulse is known as the range gate. During the range gate, the GmAPD and its integrated readout circuitry is sensitive to single photons. The high quantum efficiency in the GmAPD results in a high probability of generating a photoelectron. The few volts of overbias ensure that each free electron has a high probability of creating the growing avalanche which produces the volt-level pulse that is detected by the CMOS readout circuitry. This operation is more particularly described in U.S. Pat. No. 7,301,608, the disclosure of which is hereby incorporated by reference herein.

Unfortunately, during photon detection, the GmAPD does not distinguish among free electrons generated from laser pulses, background light, and thermal excitations within the absorber region (dark counts). High background and dark count rates are directly detrimental because they introduce noise (see, e.g., FIG. 7 of Pat. No. 7,301,608) and are indirectly detrimental because they reduce the effective sensitivity to signal photons that arrive later in the range gate. See generally, M. Albota, “Three-dimensional imaging laser radar with a photon-counting avalanche photodiode array and microstrip laser”, Applied Optics, Vol. 41, No. 36, Dec. 20, 2002, the disclosure of which is hereby incorporated by reference herein. Nevertheless, single photon counting GmAPDs are favored due to efficient use of the power-aperture.

There presently exist several techniques for extracting the desired signal from the noise in a point cloud acquired by a GmAPD LADAR. Representative techniques include Z-Coincidence Processing (ZCP) that counts the number of points in fixed-size voxels to determine if a single return point is noise or a true return, Neighborhood Coincidence Processing (NCP) that considers points in neighboring voxels, and various hybrids thereof (NCP/ZCP). See P. Ramaswami, “Coincidence Processing of Geiger-Mode 3D Laser Radar Data”, Optical, Society of America, 2006, the disclosure of which is hereby incorporated by reference herein.

In addition to removal of noise from a point cloud through the use of NCP or ZCP techniques, it is often desirable to enhance the resulting image. Prior art image enhancement techniques include unsharp masking techniques using a highpass filter, techniques for emphasizing medium-contrast details more than large-contrast details using adaptive filters and statistical differential techniques that provide high enhancement in edges while presenting a low effect on homogenous areas.

### SUMMARY OF THE INVENTION

In one embodiment, a method for processing XYZ point cloud of a scene acquired by a GmAPD LADAR is disclosed. The method of this embodiment includes: voxelizing and defocusing the XYZ point cloud obtained from the GmAPD LADAR on a computing device to produce a VD point cloud; and displaying an image of the VD point cloud.

According to another embodiment, a method for processing a XYZ point cloud of a scene acquired by a GmAPD LADAR is disclosed. The method of this embodiment includes: Z-clipping the XYZ point cloud adaptive histogramming to produce a Z-clipped point cloud; voxelizing and defocusing the XYZ point cloud obtained from the GmAPD LARAR to produce a VD point cloud based upon at least one of desired pixel size, photon spreading, timing accuracy, sensor crosstalk, expected probability of detection or probability of false alarm and the desired sensitivity as may be selected by the operator; thresholding the vD point cloud to produce a first thresholded point cloud; sharpening the first thresholded point cloud in the X-Y plane by highpass filtering to produce a sharpened point cloud; thresholding the sharpened point cloud to produce a second thresholded point cloud; mitigating timing uncertainty in the second thresholded point cloud by deconvolving the second thresholded point cloud in the vertical direction to produce a deconvolved point cloud; thresholding and cleansing the deconvolved point cloud in the vertical direction to produce a thresholded/cleansed point cloud; and displaying an image of the thresholded/cleansed point cloud by counting photons at points in the thresholded/cleansed point cloud.

According to another embodiment, a system for processing a XYZ point cloud of a scene acquired by a GmAPD LADAR is disclosed. The system of this embodiment includes an image processor for voxelizing and defocusing the XYZ point cloud obtained from the GmAPD LADAR to produce a VD point cloud and a display that displays an image of the VD point cloud.

### BRIEF DESCRIPTION OF THE DRAWINGS

For a fuller understanding of the present disclosure and its advantages, reference is now made to the following description, taken in conjunction with the accompanying drawings, in which:

FIG. 1 is a diagrammatic view of a typical GmAPD LADAR that may be employed by the present invention to acquire an XYZ point cloud representing the image of the scene of interest;

FIG. 2 is a process flow diagram of the method of the invention implemented on an image processor for display or further processing;

FIG. 3 is a diagrammatic view of adaptive histogramming;

FIG. 4 is a diagrammatic view of the Defocusing (low-pass) Matrix employed in the method of the invention; and

FIG. 5 is a diagrammatic view of the Refocussing (high-pass) Matrix employed in the method of the invention.

Similar reference characters refer to similar parts throughout the several views of the drawings.

### DETAILED DESCRIPTION OF THE PREFERRED EMBODIMENT

The following description is of the best mode presently contemplated for carrying out the invention. This description is not to be taken in a limiting sense, but is made merely for the purpose of describing one or more preferred embodiments of the invention. The scope of the invention should be determined with reference to the claims.

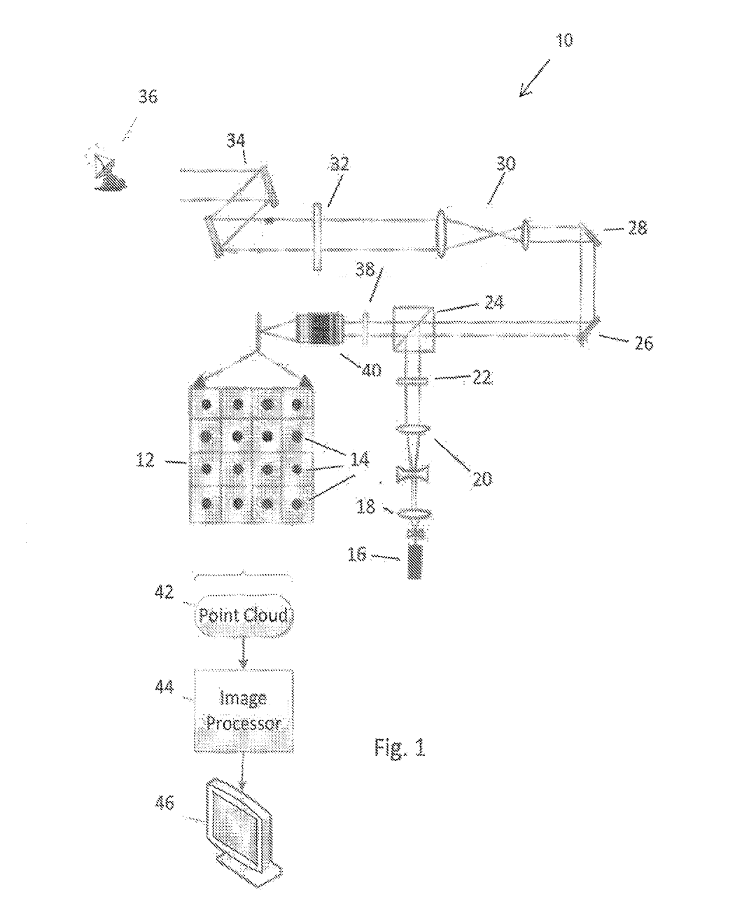

The apparatus and method of the invention comprises a typical GmAPD LADAR 10 described above in connection with FIG. 1 to acquire a point cloud 42A of XYZ data of a scene of interest 36 that is provided to an image processor 44. It shall be understood without departing from the spirit and scope of the invention, that neither the apparatus nor method of the invention is limited to any particular type or brand of GmAPD LADARs 10.

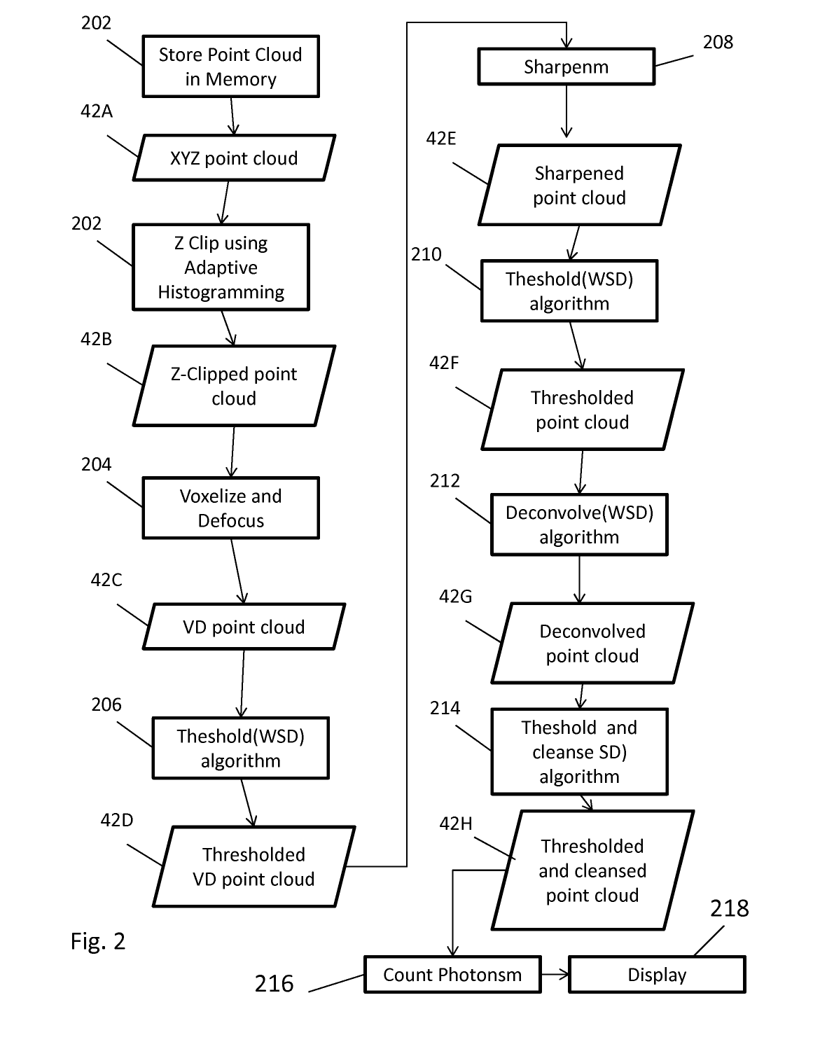

The image processor 44 may be embodied in a general purpose computer with a conventional operating system or may constitute a specialized computer without a conventional operating system so long as it is capable of processing the XYZ point cloud 42A in accordance with the process flow diagram of FIG. 2. Further, it shall be understood without departing from the spirit and scope of the invention, that neither the apparatus nor the method of the invention is limited to any particular type or brand of image processor 44.

As shown in FIG. 2, a method according to one embodiment includes storing the XYZ point cloud 42A of data into the memory of the image processor 44 at block 202. The memory may comprise any type or form of memory. The image processor 44 may comprise a computational device such as application specific integrated circuits (ASIC), or a central processing unit (CPU), digital signal processor (DSP) or field-programmable gate arrays (FGPA) containing firmware or software, that sequentially performs the following computations on the XYZ point cloud 42A.

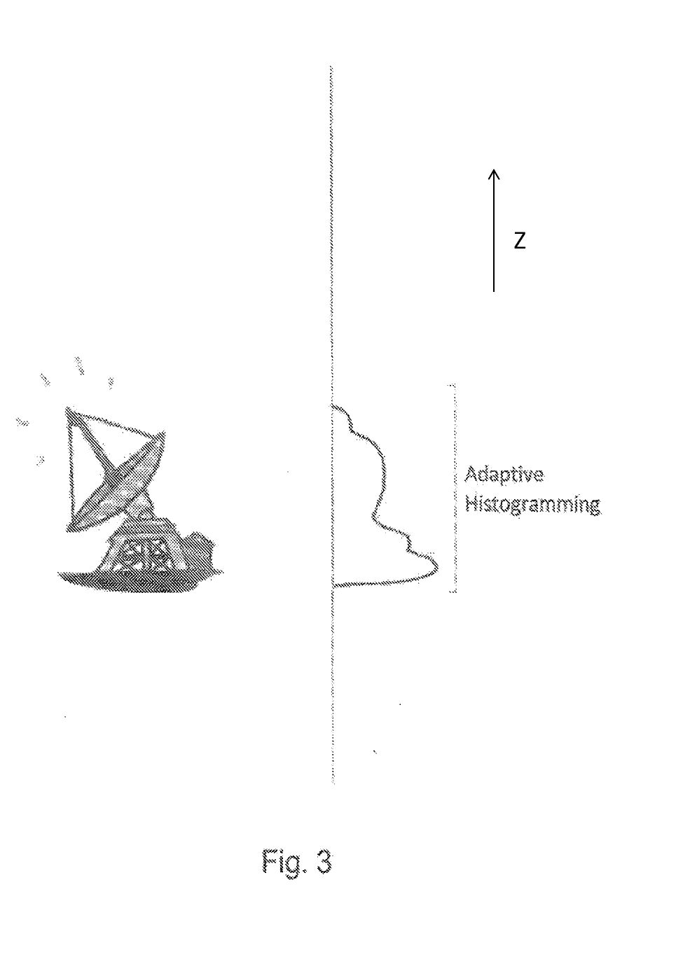

After being stored, the XYZ point cloud 42A is Z-clipped based on adaptive histogramming at block 202 to form a Z-clipped point cloud 42B. The Z-clipping performed at block 202 can include, for example, applying histogram equalization in a window sliding over the image pixel-by-pixel to transform the grey level of the central window pixel. However, to reduce the noise enhancement and distortion of the field edge, as shown in FIG. 3, a contrast-limited adaptive histogram equalization is preferably performed in the Z-direction to clip histograms from the contextual regions before equalization, thereby diminishing the influence of dominate grey levels.

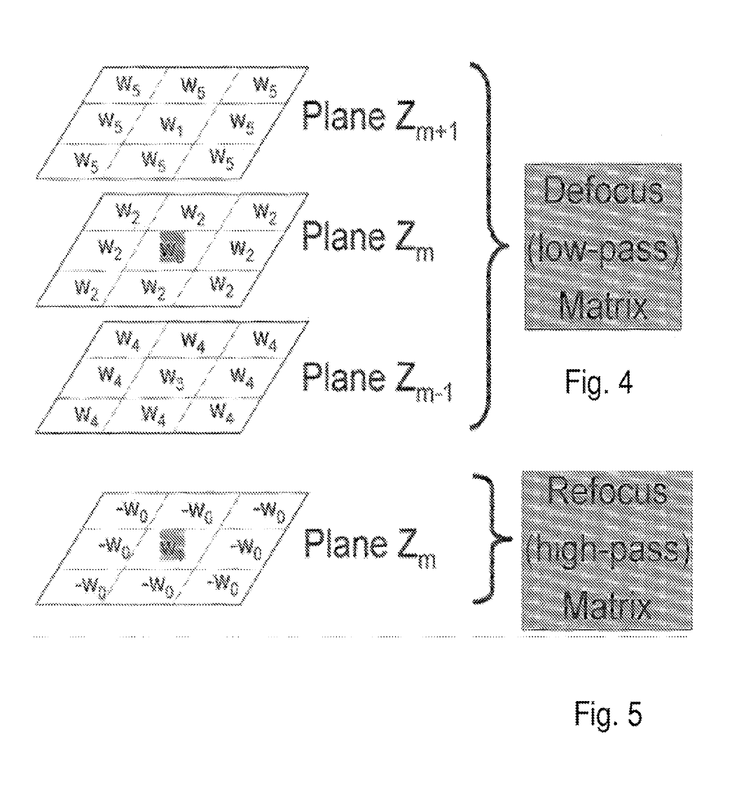

The Z-clipped point cloud 42b then, at block 204, is voxelized and defocused to form a VD point cloud 42c. Voxelizing a 3D point cloud is known in the art and not discussed further herein. The operations of block 204 can include, for example, utilizing the defocus (low-pass) matrix of FIG. 4. The matrix shown in FIG. 4 is based upon desired pixel size, photon spreading (i.e., expected dispersion), timing accuracy, sensor crosstalk, expected probability of detection and probability of false alarm and the desired sensitivity (low, medium or high) as may be selected by the operator. Notably, the voxelizing and defocusing in three dimensions eliminates (or substantially reduces) noise and distributes energy to accommodate dispersive targets.

Referring again to FIG. 2, the resulting VD point cloud 42C is thresholded at block 206 to reduce processing time. The resulting thresholded point cloud 42D is saved in memory for further processing according to the method of the invention. To reduce processing time, the thresholded point cloud 42D is sharpened in the X-Y plane by a refocus (high-pass) matrix as illustrated in FIG. 5 at block 208. The resulting sharpened point cloud 42E can then be thresholded again at block 210 to reduce additional noise around the edges of the scene thereby sharpening the image.

The resulting thresholded point cloud 42F can then be deconvolved at block 212 in the vertical Z direction {. . . , −d2, −d1, −d0, +d0, +d1, +d2, . . . } using a spiking function to mitigate timing uncertainty. The resulting deconvolved point cloud 42G can then by thresholded and cleansed downwardly in the Z direction at block 214 to minimize processing. The result is thresholded/cleansed point cloud 42H that represents the photons returned from the scene.

At block 216, thresholded/cleansed point cloud 42H representing the photons returned from the scene, are counted at each point in the scene 46 and the resulting image is displayed via display 46 at block 218. It shall be understood that in various embodiments any of the previously described point clouds could have their photons counted and be displayed.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for processing XYZ point cloud of a scene acquired by a GmAPD LADAR, comprising the steps of:
voxelizing and defocusing the XYZ point cloud obtained from the GmAPD LADAR on a computing device to produce a VD point cloud; and
displaying an image of the VD point cloud.

2. The method as set forth in claim 1, wherein the step of voxelizing and defocussing the XYZ point cloud is based upon at least one of:
desired pixel size;
photon spreading;
timing accuracy;
sensor crosstalk;
expected probability of detection; and
probability of false alarm and the desired sensitivity as may be selected by the operator.

3. The method as set forth in claim 2, wherein the step of displaying an image of the VD point cloud comprises counting and scaling photons at points in the VD point cloud.

4. The method as set forth in claim 2, further including the step of sharpening the VD point cloud in the X-Y plane to produce a sharpened point cloud and wherein the step of displaying the image of the VD point cloud comprises displaying the image of the sharpened point cloud.

5. The method as set forth in claim 4, wherein the step of sharpening the VD point cloud in the X-Y plane to produce the sharpened point cloud comprises highpass filtering.

6. The method as set forth in claim 4, further including the step of mitigating timing uncertainty in the VD point cloud by deconvolution to produce a deconvolved point cloud and wherein the step of displaying an image of the VD point cloud comprises an image of the deconvolved point cloud.

7. The method as set forth in claim 6, wherein the step of mitigating timing uncertainty in the VD point cloud by deconvolution comprises deconvolving the VD point cloud in the vertical direction.

8. The method as set forth in claim 6, further including the step of thresholding the sharpened point cloud to produce a thresholded point cloud and wherein the step of mitigating timing uncertainty in the VD point cloud by deconvolution comprises mitigating the timing uncertainty in the thresholded point cloud.

9. The method as set forth in claim 8, wherein the step of Z-clipping the XYZ point cloud to produce a Z-clipped point cloud and wherein the step of voxelizing and defocusing the XYZ point cloud comprises voxelizing and defocusing on the Z-clipped point.

10. The method as set forth in claim 9, further including the step of Z-clipping the XYZ point cloud comprises adaptive histogramming.

11. The method as set forth in claim 4, further including the step of thresholding the VD point cloud to produce a thresholded point cloud and wherein the step of sharpening the VD point cloud comprises sharpening the thresholded point cloud.

12. The method as set forth in claim 2, further including the step of thresholding and cleansing the deconvolved point cloud in the vertical direction to produce a thresholded/cleansed point cloud and wherein the step of displaying an image of the deconvolved point cloud comprises displaying an image of the thresholded/cleansed point cloud.

13. A method for processing a XYZ point cloud of a scene acquired by a GmAPD LADAR, comprising the steps of:
Z-clipping on a computing device the XYZ point cloud adaptive histogramming to produce a Z-clipped point cloud;
voxelizing and defocusing the XYZ point cloud obtained from the GmAPD LARAR to produce a VD point cloud based upon at least one of desired pixel size, photon spreading, timing accuracy, sensor crosstalk, expected probability of detection or probability of false alarm and the desired sensitivity as may be selected by the operator;
thresholding the vD point cloud to produce a first thresholded point cloud;
sharpening the first thresholded point cloud in the X-Y plane by highpass filtering to produce a sharpened point cloud;
thresholding the sharpened point cloud to produce a second thresholded point cloud;
mitigating timing uncertainty in the second thresholded point cloud by deconvolving the second thresholded point cloud in the vertical direction to produce a deconvolved point cloud;
thresholding and cleansing the deconvolved point cloud in the vertical direction to produce a thresholded/cleansed point cloud; and
displaying an image of the thresholded/cleansed point cloud by counting photons at points in the thresholded/cleansed point cloud.

14. A system for processing a XYZ point cloud of a scene acquired by a GmAPD LADAR comprising:
an image processor for voxelizing and defocusing the XYZ point cloud obtained from the GmAPD LADAR to produce a VD point cloud; and
a display that displays an image of the VD point cloud.

15. The system as set forth in claim 14, wherein said voxelizing and defocusing the XYZ point cloud is based upon at least one of:
desired pixel size;
photon spreading;
timing accuracy;
sensor crosstalk;
expected probability of detection; and
probability of false alarm and the desired sensitivity as may be selected by the operator.

16. The system as set forth in claim 15, wherein the image processor counts photons and scales with square root at points in the VD point cloud for display.

17. The system as set forth in claim 15, wherein the image processor sharpens the VD point cloud in the X-Y plane to produce a sharpened point cloud and wherein the display displaying the image of the VD point cloud comprises displaying the image of the sharpened point cloud.

18. The system as set forth in claim 17, wherein the sharpening the VD point cloud in the X-Y plane comprises highpass filtering.

19. The system as set forth in claim 18, wherein the image processor mitigates timing uncertainty in the VD point cloud by deconvolution to produce a deconvolved point cloud and wherein display displaying an image of the VD point cloud comprises displaying an image of the deconvolved point cloud.

20. The system as set forth in claim 19, wherein mitigating timing uncertainty in the VD point cloud by deconvolution comprises deconvolving the VD point cloud in the vertical direction.
